(19) United States
(12) Patent Application Publication
(10) Pub. No.: US 2010/0285174 A1
(43) Pub. Date: Nov. 11, 2010

(54) Focaccia bread and recipe

(75) Inventor: Rima Barkett, Stockton, CA (US)

Correspondence Address: AMPACC Law Group, 3500 188th Street SW, Suite103, Lynnwood, WA, 98037, US

(73) Assignee: A Tavola Together, Stockton, CA (US)

(21) Appl. No.: 12/800,312

(22) Filed: May 11, 2010

Related U.S. Application Data
(60) Provisional application No. 61/177,213, filed on May 11, 2009.

(51) Int. Cl. A21D 8/02; A21D 10/00

(52) U.S. Cl. 426/19; 426/62

(57) ABSTRACT

A pre-mixed package for making focaccia bread. The package includes a polymeric package material having an inner region and an outer region, e.g., plastic bag, sealed plastic bag, coated bag. The package includes at least a flour material having a volume and weight provided within the inner region, and a yeast material mixed with the flour material. The polymeric package material is substantially sealed from an exterior region for shipping, storage, and distribution before being used. Of course, there can be other variations, modifications, and alternatives.

### CROSS-REFERENCES TO RELATED APPLICATIONS

Not Applicable

### STATEMENT AS TO RIGHTS TO INVENTIONS MADE UNDER FEDERALLY SPONSORED RESEARCH AND DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates generally to baking a certain bread that is fuller and more spongy than conventional flat breads. More particularly, the present invention provides a method for making what is known as focaccia bread or the like. More specifically, the present invention provides a method for baking a certain focaccia bread having a higher sponge like characteristic than conventional flat breads. Merely by way of example, the focaccia bread can be used along with meals and be consumed by itself, but it will be recognized that the invention has a much broader range of applicability.

As background to the reader, it may be helpful to understand the beginnings of focaccia bread, see www.wikipedia.org as the following descriptions. “Focaccia (Italian pronunciation: [fo'kat∫:a]) is a flat oven-baked Italian bread, which may be topped with herbs or other ingredients. Focaccia is related to pizza, but not considered to be the same. Focaccia is quite popular in Italy and is usually seasoned with olive oil and sometimes herbs, and may be topped with onion, cheese and meat, or flavored with a number of vegetables. However, by far the most typical focaccia is simply baked dough topped with olive oil and a simple herb like rosemary or sage, and salted with coarse salt. It is very popular as a snack in Italy and school children will often purchase a slice from a baker on the way to school, to enjoy at break time.”

“In the late 1800's an Italian immigrant to the United Kingdom created a version of focaccia with a unique English twist. The local baker to Kings Clipstone, Nottinghamshire developed his version, known locally as Italian Lard Bread, using that staple ingredient of every Englishman's diet at that time in history, lard.”

“Focaccia doughs are similar in style and texture to pizza doughs, consisting of high-gluten flour, oil, water, salt and yeast. It is typically rolled out or pressed by hand into a thick layer of dough and then baked in a stone-bottom or hearth oven. Bakers often puncture the bread with a knife to relieve bubbling on the surface of the bread.”

“Also common is the practice of dotting the bread. This creates multiple wells in the bread by using a finger or the handle of a utensil to poke the unbaked dough. As a way to preserve moisture in the bread, olive oil is then spread over the dough, by hand or with a pastry brush prior to rising and baking. In the northern part of Italy, lard will sometimes be added to the dough, giving the focaccia a softer, slightly flakier taste. Focaccia recipes are widely available, and with the popularity of bread machines, many cookbooks now provide version of dough recipes that do not require hand kneading.”

“Focaccia can be used as a side to many meals, as a base for pizza, or as sandwich bread.” www.wikipedia.org. Although highly desirable, focaccia can continue to be improved.

### BRIEF SUMMARY OF THE INVENTION

According to the present invention, techniques related to baking a certain bread that is fuller and more spongy than conventional flat breads are provided. More particularly, the present invention provides a method for making what is known as focaccia bread or the like. More specifically, the present invention provides a method for baking a certain focaccia bread having a higher sponge like characteristic than conventional flat breads. Additionally, the present focaccia bread is healthier and more easily eaten and digested, while tasting good too. Merely by way of example, the focaccia bread can be used along with meals and be consumed by itself, but it will be recognized that the invention has a much broader range of applicability.

In a specific embodiment, the present invention provides a method for making a focaccia bread. The method includes providing a pre-mixed package (e.g., polymer, plastic, coated plastic, sealed plastic bag) comprising at least a mixture of a flour material and a yeast material for the focaccia bread. The mixture may also include other ingredients such as salt, species, and the like. The method includes opening the package to expose the mixture and placing the mixture into a vessel. The method introduces carbonated water to the mixture to subject the mixture with the carbonated water. The method mechanically stirs and/or kneads the mixture with the carbonated water to form a dough having a dough-like or paste-like consistency. The method allows the dough to rise at a temperature ranging from about 65 to about 110 degrees F. to a first determined level or other suitable temperature. The method also includes spreading the dough over a spatial region of a baking sheet (or pan) to form a thickness of dough material for the focaccia bread. In a specific embodiment, the baking sheet is coated or contains a volume of oil, such as olive oil or other suitable oil. The method allows the thickness of dough material to rise at a temperature ranging from about 65 to about 110 degrees F. to a second determined level or other suitable temperature. The method subjecting the thickness of dough material to a baking temperature ranging from about 400 to about 495 degrees F. to form the focaccia bread, which is suitable for eating once it is cooled and absorbs any remaining oil from the baking sheet.

In a specific alternative embodiment, the present invention provides a pre-mixed package for focaccia bread. The package includes a polymeric package material having an inner region and an outer region, e.g., plastic bag, sealed plastic bag, coated bag. The package includes at least a flour material having a volume and weight provided within the inner region, and a yeast material mixed with the flour material. The polymeric package material is substantially sealed from an exterior region for shipping, storage, and distribution before being used. Of course, there can be other variations, modifications, and alternatives.

In an alternative specific embodiment, the present invention provides a method for making a focaccia bread. The method includes providing at least a mixture of a flour material and a yeast material for the focaccia bread. The mixture may also include other ingredients such as salt, species, and the like. The method introduces carbonated water to the mixture to subject the mixture with the carbonated water. The method mechanically stirs and/or kneads the mixture with the carbonated water to form a dough material having a dough-like or paste-like consistency. The method allows the dough to rise at a temperature ranging from about 65 to about 90 degrees F. to a first determined level or other suitable temperature. The method also includes spreading the dough over a spatial region of a baking sheet (or pan) to form a thickness of dough material for the focaccia bread. In a specific embodiment, the baking sheet is coated or contains a volume of oil, such as olive oil or other suitable oil. The method allows the thickness of dough material to rise at a temperature ranging from about 65 to about 90 degrees F. to a second determined level or other suitable temperature. The method subjecting the thickness of dough material to a baking temperature ranging from about 400 to about 495 degrees F. to form the focaccia bread, which is suitable for eating once it is cooled and absorbs any remaining oil from the baking sheet.

Many benefits are achieved by way of the present invention over conventional techniques. For example, the present technique provides an easy to use process that relies upon conventional technology. In some embodiments, the method provides a focaccia bread that may be healthier and tastes great. That is, the bread is free from conventional lard or other heavy oils. In a specific embodiment, the present package can be used easily by someone with little or no experience making focaccia bread. In a preferred embodiment, the present package uses yeast which is not activated first by warm water, as conventional techniques, but uses an easy to implement mixture of materials, including flour and yeast. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow

### BRIEF DESCRIPTION OF THE DRAWINGS

FIG. 1 is a simplified flow diagram of a method of making focaccia bread using a pre-mixed package of ingredients according to an embodiment of the present invention.

### DETAILED DESCRIPTION OF THE INVENTION

According to the present invention, techniques related to baking a certain bread that is fuller and more spongy than conventional flat breads are provided. More particularly, the present invention provides a method for making what is known as focaccia bread or the like. More specifically, the present invention provides a method for baking a certain focaccia bread having a higher sponge like characteristic than conventional flat breads. Merely by way of example, the focaccia bread can be used along with meals and be consumed by itself, but it will be recognized that the invention has a much broader range of applicability.

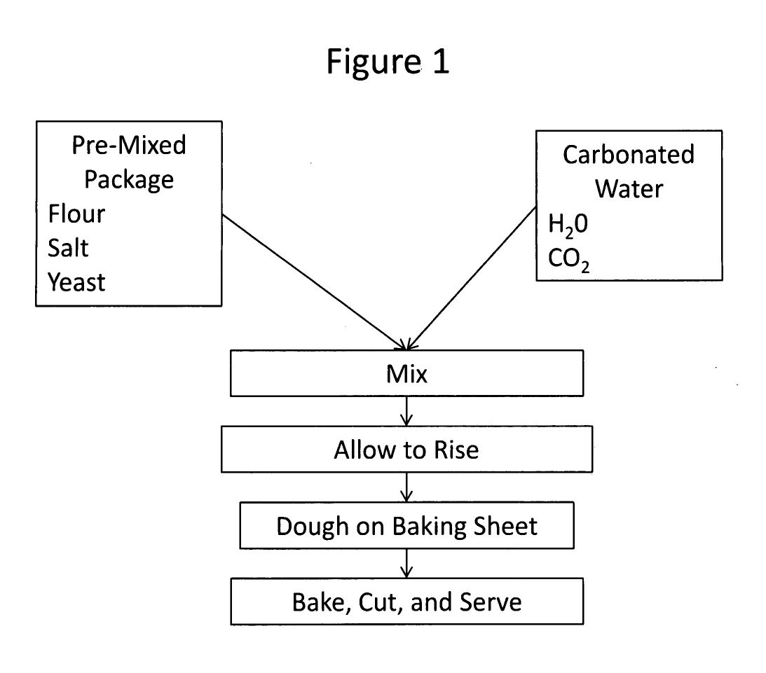

In a specific embodiment, a recipe for making focaccia bread can be summarized as follows. As an example, the recipe is designed for twelve servings, although it may more or fewer depending upon each person's appetite. In a specific embodiment, the present method for making the focaccia bread can be parsed into three distinct phases, although the phases may overlap or be called other terms according to one or ordinary skill in the art. The phases include a preparatory time, a rise time, and a cooking or baking time according to this example. In a specific embodiment, the present method includes (1) preparatory time: 5 minutes; rise time: 2 hours; and cook time: 20 minutes. See also FIG. 1, as an example. Of course, there can be other variations, modifications, alternatives. In the present example, the following starting materials are provided.

3 cups flour

1 tablespoon sea salt

1 tablespoon active dry yeast (about 1 1/2 packages)

1 1/4 cups club soda, or sparkling water (fresh from the bottle)

1/2 cup olive oil

Using the above materials according to a specific embodiment, the flour is poured into a large mixing bowl. In www.wikipedia.org, “flour is a powder made of cereal grains, other seeds, or roots. It is the main ingredient of bread, which is a staple food for many civilizations, making the availability of adequate supplies of flour a major economic and political issue at various times throughout history. Wheat flour is one of the most important foods in European, North American, Middle Eastern and North African cultures, and is the defining ingredient in most of their styles of breads and pastries . . . Flour contains high proportion of starches, which are complex carbohydrates also known as polysaccharides. Leavening agents are used with some flours, especially those with significant gluten content, to produce lighter and softer baked products by embedding small gas bubbles. The production of flour has also historically driven technological development, as attempts to make gristmills more productive and less labor-intensive led to the watermill and windmill, terms now applied more broadly to uses of water and wind power for purposes other than milling.” In a specific embodiment, commonly used wheat flour or other suitable flour may be used. Next, the method adds salt (e.g., sea salt) and yeast to the flour. In a specific embodiment, the yeast is commonly what is known as baker's yeast, although others may also be used. While dry, the salt, yeast, and flour are combined and mixed by string them together.

In a preferred embodiment, the salt, yeast, and flour may be premixed and sealed in a package, e.g., plastic bag, plastic box, container, metal container, or others. In contrast, conventional yeast is often placed separate from the flour and then placed in warm water to active it. It is unexpected that the yeast is activated in an unconventional manner and in fact by way of an alternative mechanism, which is not fully understood by one of ordinary skill in the art. That is, conventional water temperature does not activate the yeast according to one or more embodiments. In a preferred embodiment, other materials can also be pre-mixed in the package, which will be sold, offered for sale, and distributed for use by a customer. Of course, there can be other variations, modifications, and alternatives.

In a preferred embodiment, club soda or sparkling water is introduced into the mixture. As an example, club soda, sparking water, or carbonated water or the like can be used. In a specific embodiment, “carbonation refers to the dissolving of carbon dioxide in an aqueous solution. The process usually involves high pressures of carbon dioxide. Upon lowering of this pressure, the carbon dioxide is released from the solution as bubbles. This effect is observed in carbonated beverages. Since the carbonation of aqueous solutions requires pressure, the opening of containers of such solutions is accompanied by an audible pop. Carbonation can also describe a chemical reaction, one example of which is a key step in photosynthesis.” www.wikipedia.org, carbonation.

As an example, “the process of carbon dioxide bubbling out of solution is represented by the following chemical reaction, aqueous carbonic acid converts to carbon dioxide:

H₂CO₃→H₂O+CO₂

Carbon dioxide is poorly soluble in water, so it separates as a gas.” www.wikipedia.org, carbonation.

“Carbonated water, also known as sparkling water, fizzy water, seltzer, and water with gas, (collectively as an aerated beverage), is plain water into which carbon dioxide gas has been dissolved, and is the major and defining component of most soft drinks. The process of dissolving carbon dioxide gas is called carbonation. It results in the formation of carbonic acid (which has the chemical formula H2CO3).” www.wikipedia.org, carbonated water.

“Carbonated water, also known as soda water, can be produced in the home by “charging” a refillable seltzer bottle by filling it with water and then adding carbon dioxide. Club soda may be identical to plain carbonated water or it may contain a small amount of table salt, sodium citrate, sodium bicarbonate, potassium bicarbonate, potassium citrate, potassium sulfate, or disodium phosphate, depending on the bottler. These additives are included to emulate the slightly salty taste of homemade soda water. The process can also occur naturally to produce carbonated mineral water, such as in Mihalkovo in the Bulgarian Rhodopes, or Medzitlija in Macedonia.” www.wikipedia.org, carbonated water. Of course, there can be other variations, modifications, and alternatives.

In a specific embodiment, the mixture is formed into a dough-like consistency and beat for about 3 minutes using with an electric mixer fitted with a dough hook attachment or other suitable means or mechanism. In a preferred embodiment, the electric mixture is initiated at low and increased in speed to high, although there can be some variations. Of course, there can be other alternatives and modifications. In an alternative embodiment, the method mixes the dough with human hands, until the flour has absorbed all the water and does not stick to the bowl but a little to the fingers of the hands. Again, there can be other variations, modifications, and alternatives.

In a specific embodiment, the mixing bowl with dough is set aside. In a preferred embodiment, the bowl is covered with plastic wrap to seal the dough or partially seal the bowl. In a specific embodiment, the dough is allowed to rise preferably overnight at room temperature or in a warm place for about two hours or so, but again, there can be variations. In a specific embodiment, an oven heated for just a couple of few minutes, makes a great warm place during the day, or overnight. Again, the goal is to allow the dough to rise to a desirable level.

Next, the method uses a baking sheet, which has been treated with oil or other suitable material. In a preferred embodiment, olive oil is used. The method pours olive oil into a 9×12-inch baking sheet with 1-inch sides, although there may be variations. In a specific embodiment, the dough is transferred to the baking sheet, where it is gently spread to fill an entirety or substantially an interior periphery of the baking sheet to form a thickness of dough material. In a specific embodiment, the thickness of dough material can vary or be fairly consistent in dimension, although there can be variations. As an example using hands, oil is placed on the bottom of the pan, on top of the dough or other regions. Alternatively, the dough is treated and/or bathed in oil by flipping it on each or both sides. In a specific embodiment, the method subjects the top of the dough with little dimples made using fingers or other mechanical means or device. In a specific embodiment, the dough is allowed to rise again in a warm place (e.g., 65 to 70 degrees F., or 75 to 85 degrees F. or others) for about an hour or so, although there can be other variations. The method can also provide additional dimples on the top of the dough. Of course, there can be other variations, modifications, and alternatives.

In a specific embodiment, the thickness of dough material on the pan (e.g., baking sheet) is placed in an oven. Preferably, the oven is preheated to about 450 degrees F., although there can be slightly higher or lower temperatures depending upon the specific embodiment. In a specific embodiment, the method subjects the thickness of dough material to allow it to bake for about 20-25 minutes or until golden brown at a desirable time. In a specific embodiment, the method removes the baked focaccia bread from the oven. The baked bread, which is hot, is allowed to stand for about 10 minutes or until the oil is absorbed. In a specific embodiment, the baked bread is separated by cuts in squares or long slices and served the same day or other suitable time. The baked focaccia bread is fluffier, and more consistent than conventional focaccia bread. Of course, there can be other variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for making a focaccia bread comprising:
providing a pre-mixed package comprising at least a mixture of a flour material and a yeast material for the focaccia bread;
opening the package to expose the mixture;
placing the mixture into a vessel;
subjecting the mixture with a carbonated water;
mechanically stirring the mixture with the carbonated water to form a dough having a dough-like consistency;
allowing the dough to rise at a temperature ranging from about 65 to about 110 degrees F. to a first determined level;
spreading the dough over a spatial region of a baking sheet to form a thickness of dough material for the focaccia bread;
allowing the thickness of dough material to rise at a temperature ranging from about 65 to about 110 degrees F. to a second determined level; and
subjecting the thickness of dough material to a baking temperature ranging from about 400 to about 495 degrees F. to form the focaccia bread.

2. The method of claim 1 wherein the pre-mixed package comprises a salt species.

3. The method of claim 1 wherein the pre-mixed package is sealed and configured in a polymer material.

4. The method of claim 1 wherein the carbonated water is selected from soda water, mineral water, seltzer water, or soda water.

5. The method of claim 1 wherein the baking sheet is coated with olive oil before spreading the dough.

6. The method of claim 1 wherein the focaccia bread has a fuller configuration than conventional focaccia bread.

7. The method of claim 1 wherein the mechanically stirring comprises a low speed stirring to a high speed stirring.

8. The method of claim 1 wherein the pre-mixed package is provided in a sealed plastic bag.

9. The method of claim 1 wherein the carbonated water is added at about room temperature.

10. The method of claim 1 wherein the baking temperature is about 475 degrees F.

11. A pre-mixed package for focaccia bread comprising a polymeric package material having an inner region and an outer region, a flour material having a volume and weight provided within the inner region; a yeast material mixed with the flour material, the yeast material provided within the inner region; whereupon the polymeric package material is substantially sealed from an exterior region.

12. The package of claim 11 wherein the polymeric package material is substantially free from moisture in the inner region.

13. The package of claim 11 wherein the polymeric package material is substantially free from impurities in the inner region.

14. The package of claim 11 further comprising a salt material mixed with the flour material.

15. The package of claim 11 wherein polymeric package material is configured in a box for display.

16. The package of claim 11 wherein the polymeric package is plastic.

17. The package of claim 11 wherein the polymeric package is coated with a metal material.

18. The package of claim 11 wherein the polymeric package is configured as an enclosure for the flour material and the yeast.

19. The package of claim 11 further comprising a bottle of carbonated water within a vicinity of the polymeric package.

20. A method for making a focaccia bread comprising:
providing a flour material and a yeast;
placing flour material and the yeast into a vessel to form a mixture of materials;
subjecting the mixture of materials with a carbonated water;
mechanically stirring and/or kneading the mixture of materials with the carbonated water to form a dough having a dough-like consistency;
allowing the dough to rise at a first temperature range to a first determined level;
spreading the dough over a spatial region of a baking sheet to form a thickness of dough material for the focaccia bread;
allowing the thickness of dough material to rise at a second temperature range to second determined level; and
subjecting the thickness of dough material to a baking temperature ranging from about 400 to about 495 degrees F. to form the focaccia bread.
